(19) United States
(12) Patent Application Publication
(10) Pub. No.: US 2002/0126640 A1
(43) Pub. Date: Sep. 12, 2002

(54) CDMA base station and transmission diversity control method

(75) Inventor: Masahiro Komatsu, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/087,857

(22) Filed: Mar. 5, 2002

(30) Foreign Application Priority Data
Mar. 9, 2001 (JP) 066142/2001

(51) Int. Cl. H04B 7/216

(52) U.S. Cl. 370/335; 370/252

(57) ABSTRACT

To perform a transmission diversity control in a best state by monitoring a transmission line state of an up-link and a transmission line state of a down-link. A base station, which controls a transmission state of a base station having not less than two transmission antennas by a transmission state control command transmitted from a mobile station via the up-link, includes: a receiving portion which receives a signal of the up-link; an up-link transmission line state estimation portion which estimates a transmission line state of the up-link with the transmission antenna of the mobile station from the above described received signal; a down-link transmission line state estimation portion which estimates a transmission line state of the down-link from the received signal; a transmission state control portion which controls the transmission state of the base station from the transmission state control command taken from the above described receiving portion, the transmission line state of the up-link, the estimated down-link transmission line state; and a transmission portion which performs transmission processing instructed from the transmission state control portion.

### BACKGROUND OF THE INVENTION

1. Field of the Invention

The present invention relates to a CDMA (Code Division Multiple Access) base station and transmission diversity control method, especially to a mobile communication device adopting a code division multiple access and a transmit-receive frequency division duplex (CDMA/FDD) system in mobile telephones such as digital land mobile telephones/portable telephones.

2. Description of the Prior Art

In general, in radio communications, by interference of component waves propagated through different paths, fluctuation is caused to a received wave level. Such a phenomenon is referred to as a “fading phenomenon” in this technical field. As a technology to overcome such a fading phenomenon, there is known a diversity technology.

As for this diversity technology, hitherto in the past, there have been known various methods and they are divided (classified) into two systems. One of the systems is the so-called “reception diversity”, which is a control system to make a receiving state at the receiving side the best and is frequently used in mobile land mobile telephones. Within this reception diversity, there are available various control methods, the one control method of which is for the receiving side to receive signals by a plurality of antennas and select the strongest signal. The other control method is to add and synthesize the received signals by a plurality of antennas by a certain ratio and obtain the strongest signal, which is referred to as a “RAKE reception”.

The other method is referred to as a “transmission diversity”, which is a system to transmit a radio wave from own antenna so that the radio wave can well reach a radio station of the other party. Specifically, this transmission diversity is a method of determining from which antenna and with what ratio the transmission is to be made for a plurality of antennas from the transmission side, which changes directivity of the transmission wave.

On the other hand, as is known, with respect to duplex communication systems between abase station and a mobile station, there are a TDD (Time Division Duplex) communication system and an FDD (Frequency Division Duplex) communication system.

In the case of the TDD communication system, separation of transmission and reception is made time-wise by using signals of the same frequency. First, in this TDD communication system, there is a method available, in which radio signals are received by a plurality of antennas and an antenna having a large signal level is decided and, from the decided antenna, transmission is made to realize the “transmission diversity”.

In contrast to this, in the case of the FDD communication system, a different frequency is used for an up-link (an up-line from the mobile station to the base station) and for a down-link (a down-line from the mobile station to the base station). In such an FDD communication system, since a state of fading is different for the up-link and the down-link, the method of realizing the transmission diversity adopted in the above described TDD communication system cannot be applied.

For this reason, in the case of the FDD communication system, the transmission diversity is performed by a “closed loop control” to be described as follows. First, signals having different transmission series (different information symbols or different diffusion codes) are transmitted from each antenna of not less than two pieces from the base station in such a manner as to differentiate the antennas. The mobile station receives signals transmitted from each antenna of the base station, and sends a transmission state control command to the base station according to the receiving state of the down-link which was received. In response to this transmission state control command, a ratio and a phase differences of the transmission level of the antenna, which the base station transmits, are controlled.

Specifically, in the closed loop control, the mobile station measures a transmission line state with each antenna of the base station with a time slot of 0.666 ms (millimeter second) as a unit, and determines how the transmission has to be made in the base station. As for the determining method at the time when the determination is made, the following three methods can be conceived. A first determining method is “by which antenna of the base station, the transmission should be made”, and a second determining method is “by what ratio, the transmission should be made by each antenna of the base station”, and a third method is “with what phase difference, the transmission should be made by each antenna of the base station”.

Presume, for example, that the determination was made that “only by either antenna of the base station, the transmission should be made” according to the above described first method. Also, presume that there are two transmission antennas: an antenna 1 and an antenna 2 available in the base station. In this case, when the determination was made that “the transmission is desired to be made by the antenna 138 , the mobile station issues an instruction via the up-link that the transmission should be made by the antenna 1 of the base station. On the contrary, when the determination was made that “the transmission is desired to be made by the antenna 2”, the mobile station issues an instruction (transmission state control command) via the up-link that the transmission should be made by the antenna 2 of the base station. The base station changes the transmission antenna from the next slot, which received the instruction according to the instruction of the transmission antenna, which was received from the mobile station.

Note that, when the determination was made that “the transmission should be made by a ratio of the transmission level instructed by each antenna of the base station” according to the above described second determination method, or when the determination was made that “the transmission should be made by a phase difference instructed by each antenna of the base station” according to the above described third method, it can be easily understood that the transmission diversity can be similarly realized by issuing an instruction from the mobile station.

Also, mixing and using both the above described second determination method and the above described third determination method can be also conceived. For example, presume that the transmission method in the base station is controlled every four-slot cycles. In this case, since the transmission state control command can be used for four bits portion, when one bit is used for a transmission ratio and three bits for instructions of eight kinds of phase differences, the transmission method of the base station can be controlled by minute accuracy. The above described method is referred to as the conventional transmission diversity.

The prior arts, which relate to the above described “transmission diversity”, have been variously proposed hitherto in the past. For example, in Japanese Patent Laid-Open No. 2000-174678 (hereinafter, referred to as a “first prior art literature”), “the radio communication system” is disclosed, which can maintain a good communication state without specifying the direction of the other party radio station. According to this first prior art literature, the control signal reading portion of a first radio station extracts a transmitted power control signal which a control signal generation portion of a second radio station has generated by a measurement result of a received quality measurement portion of the second radio station from the signal received from the second radio station. The received quality measurement portion of the first radio station switches the antenna characteristic of an antenna device to measure the received quality of the received signal and specifies the antenna characteristic to obtain still better received quality. The transmission control portion of the first radio station switches the transmission antenna characteristic of the antenna device to the antenna transmission characteristic equivalent to the above described antenna characteristic specified by the received quality measurement portion. After that, the transmission control portion of the first radio station switches the original transmission antenna characteristic to other transmission antenna characteristic when it has become clear that the received quality in the second radio station has deteriorated by the transmitted power control signal which the control signal reading portion extracted.

Also, in Japanese Patent Laid-Open No. 8-195703 (hereinafter, referred to a “second prior art literature”), “the radio communication device” is disclosed, which can perform the transmission diversity even when the first transmission is made at the stage where no information is available regarding the position and the direction of the other party or when the information directed from the master station to a plurality of all subsidiary stations is transmitted, similarly to the case of the mobile communication system. According to the radio communication device disclosed in the second prior art literature, the transmission information is diffused by the first and the second diffusers by first and second orthogonal codes which a first and a second orthogonal code generators generate and, after the diffusion, the first and the second diffusion signals are subjected to a two-phase phase modulation, respectively by a first and a second BPSK modulators by the same carrier and are transmitted from the first and the second antennas which are mutually different in a spatial position.

Further, in the Japanese Patent Laid-Open No. 9-8716 (hereinafter, referred to a “third prior art literature”) “the mobile communication device” is disclosed, which has made it possible to realize the base station transmission diversity and the transmitted power control by intermittent communication. According to this third prior art literature, the base station compares a correlation level, where the signals received by a plurality of antennas are back-diffused by a back diffusion circuit for every channel, by a comparator for each channel between the antennas and, on the basis of that result, selects from which antenna the transmission should be made. Each mobile station comprises means for transmitting a fixed pattern of a transmission frame immediately before the frame initially received after a transmit-receive shutdown section. The base station performs selection of the mobile station transmitted power control and the transmission antennas on the basis of the received power of the fixed pattern.

Japanese Patent Laid-Open No. 10-322254 (hereinafter, referred to as a “fourth prior art literature”) provides “the antenna switching diversity method”, which can maintain a good communication quality by performing the communication adopting the antenna which would make a receiving state of the mobile station the best. According to this fourth prior art literature, the base station is provided with a plurality of antennas, a plurality of receivers, a plurality of switching units and one transmitter. While the mobile station is transmitting, each antenna is connected with each receiver. A prediction circuit detects a reception level of the reception burst and an error state of the received data received by each antenna from the output of the receiver and, from the reception level of the reception burst and the error state of the received data in the past, predicts from which antenna within a plurality of antennas, the transmission should be made at the transmission timing of the base station so that the receiving state of the base station becomes the best. The antenna, which has predicted in the prediction circuit at the transmitting time of the base station that the receiving state of the mobile station becomes the best, and the transmitter are connected by the switching unit, and the transmission is performed.

Further, in Japanese Patent No. 2876517 (hereinafter, referred to as a “fifth prior art literature”), “the base station device and the mobile station device of CDMA/TDD system and the communication system performing radio communications by using the CDMA/TDD system and the communication method” is disclosed, which can apply a space diversity for the down-line also, stabilize a received electric field strength or lowly control interference by communication waves by other stations and reduce performance requirement of modulator/amplifier and the like. According to this fifth prior art literature, the base station comprises a plurality of antenna, back diffusion means for back-diffusing the received signal of the up-line of each antenna, a comparator for comparing the correlation level obtained by this back diffusion means for each channel, selection means for selecting which antenna, the transmission should be made by the transmission antenna selection signal of the comparator at the time of transmission for each channel and multiplexing means for multiplexing the transmission signal of each diffused channel for each channel.

Further, in Japanese Patent No. 3108643 (hereinafter, referred to as a “sixth prior art literature”), “the antenna switching control system” is disclosed, which can obtain sufficient diversity gains even in the mobile communication system of microwave bands. The antenna switching control system disclosed in this sixth prior art literature is an antenna switching control system in the radio communication system, which comprises a first radio station having antenna series capable of switching a plurality of characteristics and a second radio station, which receives the signal from the first radio station and has measuring means for measuring a quality of that signal.

In a first aspect of this sixth prior art literature, when the second radio station detects that, as a result of the measurement of measuring means, a quality of the received signal becomes below a predetermined value, it transmits an antenna switching signal to the first radio station. The first radio station, which received this antenna switching signal, switches and transmits in order all the combinations selectable on the characteristic of the antenna system. The second radio station, which received this signal, stores the measurement result showing the best quality among them as a reference value. Subsequently, the first radio station switches again the characteristic of the antenna system and transmits it. The second radio station compares the measuring result of this received signal and the reference value and, when the comparison result falls within a predetermined range, transmits a signal to the first radio station, which means that the characteristic of the antenna system at that time is selected. In this way, the characteristic of the antenna system is switched so that the second radio station is put into the best receiving state.

In a second aspect of this prior art literature, when the second radio station detects that the quality of the received signal became below a predetermined value as a result of the measurement by measuring means, it transmits the antenna switching signal to the first radio station. The first radio station, which received the antenna switching signal, switches and transmits in order all the combinations selectable on the characteristic of the antenna system. The second radio station transmits in order the measurement results of measuring means at the time of receiving this signal to the first radio station. The first radio station selects the characteristic of the antenna, which shows the best state in the quality of the measured signal, on the basis of the measurement results transmitted from the second radio station. In this way, the characteristic of the antenna system is switched so that the second radio station is put into the best receiving state.

According to the above described conventional transmission diversity method, when the communication quality of the up-link is bad, there is a problem that the base station misunderstands the transmission state control command received from the mobile station. Specifically, even when the mobile station issues an instruction to the effect that the transmission be made by the antenna 1, in the case where the transmission line of the up-link is in a bad state, the base station misunderstands that it was instructed to the effect that the transmission be made by the antenna 2 and ends up with performing the transmission by the antenna 2. In this case, the transmission line from the base station to the mobile station is put into a bad condition so that the communication quality is deteriorated.

For this reason, it is necessary for the base station to check whether the transmission state control command sent from the mobile station is correct or not. However, when determined by the receiving state of the up-link alone, in the case where the transmission line of the down-link is in a bad state, the mobile station sometimes prepares a transmission state control command by mistake and, when the transmission state of the base station is not adequately controlled, demodulation correctly cannot be made as a result. This is because the signals from each antenna mutually interfere when the transmissions are made at the same time by different transmission series (different information symbols or different diffusion codes) for each transmission antenna. It is also because the signals from each antenna are not satisfactorily amplified, but, on the contrary, are attenuated when the same transmission series are transmitted at the same time by controlling the phases.

Note that the first prior art literature measures the received quality of the received signal and specifies the antenna characteristic capable of obtaining the best-received quality. However, similarly to the CDMA/FDD system, when different frequencies are used for the up-link and the down-link, since the state of fading is different for the up-link and the down-link as described above, this literature cannot be applied to the CDMA/FDD system.

The second prior art literature only discloses a technological concept in which the transmission information is diffused at the transmission side and the information after the diffusion is transmitted as a plurality of radio signals being different in transmission conditions, and discloses quite a different technological concept from the technological concept aimed at by the present invention, wherein the transmission state control command is transmitted from the mobile station by the up-link and the transmission state of the base station having not less than two transmission antennas is controlled by that transmission state control command.

The third prior art literature only discloses the technological concept regarding the radio communication system of the CDMA/TDD system, which is different from the mobile communication system of the CDMA/FDD system aimed at by the present invention.

The fourth prior art literature predicts from which antenna within a plurality of transmission antennas, the transmission is made so that the receiving state of the base station becomes the best. However, similarly to the CDMA/FDD system, when the different frequencies are used for the up-link and the down-link, since the fading state is different for the up-link and the down-link as described above, this literature cannot be applied to the CDMA/FDD system.

The fifth prior art literature too only discloses the technological concept regarding the CDMA/TDD system, similarly to the above described third prior art literature, and is different from the mobile communication system of the CDMA/FDD system aimed at by the present invention.

Further, the sixth prior art literature only discloses the technological concept equivalent to the above described conventional transmission diversity method.

### BRIEF SUMMARY OF THE INVENTION

The present invention has been achieved in view of the above problems and its object is to provide a system to perform a control of a transmission diversity in a most adequate state by monitoring the state of the up-link and the state of the down-link.

According to the present invention, a base station can be obtained, wherein the transmission state control command is transmitted by the up-link so that the receiving state of the down-link in the mobile station becomes good and the transmission state of the base station having not less than two transmission antennas is controlled, and which comprises a receiving portion to receive the signal of the up-link, an up-link transfer line state estimation portion to estimate the transfer line state of the up-link from the received signal to the transmission antenna of the mobile station, a down-link transfer line state estimation portion to estimate the transfer line state of the down-link from the received signal, a transmission state control portion to control the transmission state of the base station from the transmission state control command taken from the above described receiving portion, the transfer line state of the above described up-link and the above described estimated down-link transfer line state and a transmission portion to perform transmission processing in the transmission state instructed from the above described transmission state control portion. By having the constitution as described above, the transmission diversity can be normally operated regardless of the transfer line state of the up-link and the transfer line state of the down-link.

In the above described base station, the above described up-link transfer line state estimation portion predicts (estimates) the transfer line state of the up-link from, for example, a level of the received signal or SIR of the data after demodulated or BER of the data after demodulated or FER of the data after demodulated or a level of the transfer line estimation value.

In the above described base station, the above described down-link transfer line state estimation portion predicts (estimates) the transfer line state of the down-link from, for example, a transmitted power control command column with the received signals. In this way, the transfer line state of the down-link can be estimated.

In the above described base station, the above described transmission state control portion does not follow the transmission state control command sent from the up-link, but performs the control so as to transmit by the antenna of the up-link having a good characteristic or in a specific transmission state when the transfer line state of the up-link is bad or the transfer line state of the down-link is bad and, when the transfer line state of the up-link is good and, moreover, the transfer line state of the down-link is good, performs the control so as to follow the transfer state control command sent from the up-link. In this way, even when the transfer line state of the up-link and the transfer line state of the down-link are bad, the transmission diversity function is not deteriorated.

### BRIEF DESCRIPTION OF THE DRAWINGS

FIG. 1 is a block diagram showing a mobile communication system applied with a transmission state control method of one embodiment of the present invention;

FIG. 2 is a processing explaining view of a transmission line estimation portion used in the mobile communication system shown in FIG. 1;

FIG. 3 is a view showing an operation timing example of an up-link/a down-link in the mobile communication system shown in FIG. 1;

FIG. 4 is a flowchart showing an estimation example of an up-link transmission line state in an up-link transmission state estimation portion used in the mobile communication system shown in FIG. 1;

FIG. 5 is a flowchart showing an estimation example of a down-link transmission state in a down-link transmission state estimation portion used in the mobile communication system shown in FIG. 1; and

FIG. 6 is a flowchart showing a control example of a base station transmission state in the transmission state control portion used in the mobile communication system shown in FIG. 1.

### DESCRIPTION OF THE PREFERRED EMBODIMENT

Hereinafter, the embodiment of the present invention will be described with reference to the drawings.

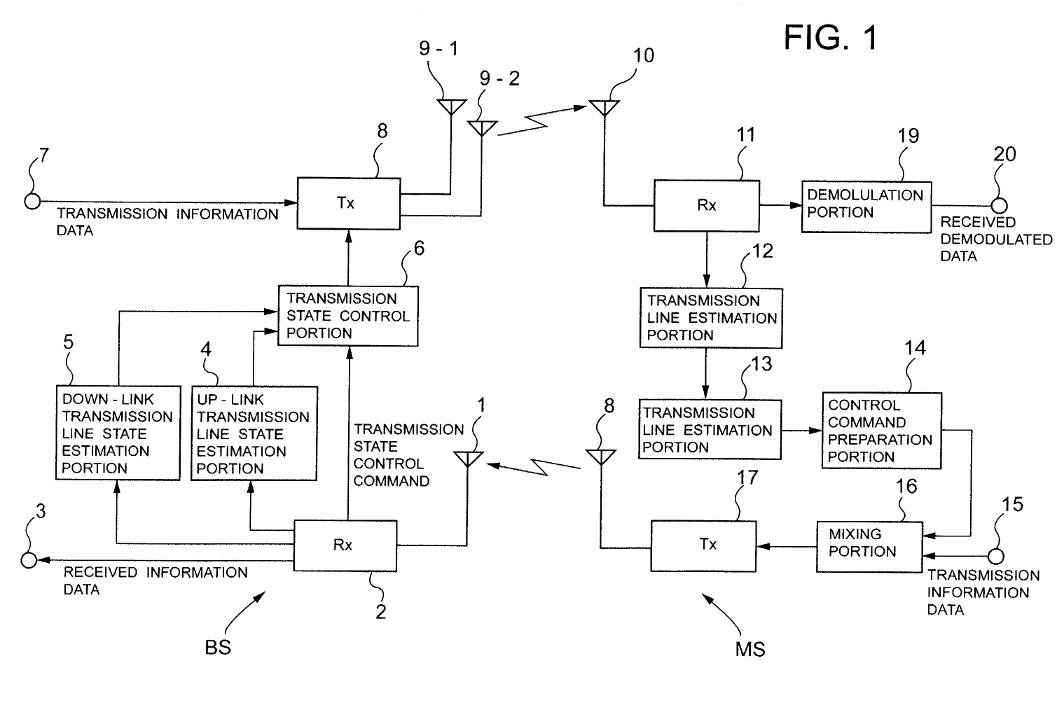

Referring to FIG. 1, a mobile communication system applied with a transmission state control method by one embodiment of the present invention will be described. The mobile communication system shown in the drawing has a base station BS and a mobile station MS, of which the left side is the base station BS and the right side the mobile station MS.

The base station BS comprises a base receiving antenna 1 which receives an up-radio signal transmitted from the mobile station MS via an up-link, a base receiving portion (Rx) 2 connected to this base receiving antenna 1, an up-received information data output terminal 3 connected to this base receiving portion 2, a down-link transfer line estimation portion 5 connected to the base receiving portion 2, an up-link transfer line state estimation portion 4 connected to the base receiving portion 2, a transmission state control portion 6 connected to the base receiving portion 2, the up-link transfer line state estimation portion 4 and the down-link transfer line state estimation portion 5, a down-transmission information data input terminal 7 to which the down-transmission information data is supplied (inputted), abase transmission portion (Tx) 8 connected to this down-transmission state data input terminal 7 and this transmission state control portion 6, and a first and a second base transmission antennas 9-1 and 9-2 which are connected to the base transmission portion 8 and transmit a down-radio signal to the mobile station MS via the down-link.

Note that, in the present embodiment, the number of base transmission antennas is two. However, needless to mention, the number may be also not less than three.

On the other hand, the mobile station MS comprises a mobile receiving antenna 10 to receive the down-radio signal transmitted from the base station BS via the down-link, a mobile receiving portion (Rx) 11 connected to this mobile receiving antenna 10, a transmission line state estimation portion 12 connected to this mobile receiving portion 11, a transmission line estimation portion 13 connected to this transmission line state estimation portion 12, a control command preparation portion 14 connected to this transmission line estimation portion 13, an up-transmission information data input terminal 15 to which the up-transmission information data is supplied (inputted), a mixing portion 16 connected to this up-transmission state data input terminal 15 and the control command preparation portion 14, a mobile transmission portion (Tx) 17 connected to this mixing portion 16, a mobile transmission antenna 18 which is connected to this mobile transmission portion 17 and transmits the up-radio signal to the base station BS via the up-link, a mobile demodulation portion 19 connected to the mobile receiving portion 11 and a down-received demodulated data output terminal 20 connected to this mobile demodulation portion 19.

In the base station BS, when the base transmission portion 8 receives the down-transmission information data from the down-transmission state data input terminal 7, it subjects the down-transmission information data to diffusion modulation. At the same time, the transmission state is controlled by the transmission state control portion 6 as described later, and the down-radio signal is transmitted to the down-link from the first and second base transmission antennas 9-1 and 9-2.

Here, the first and the second base transmission antennas 9-1 and 9-2 transmit the signals which are different in transmission series so that the mobile station MS side can differentiate the first and the second base transmission antennas 9-1 and 9-2. As for the different transmission series, different information symbols or different diffusion codes can be conceived. This signal is different from a data channel which is a signal including the transmission information data, and is referred to as a control channel. The control channel is always constant in a transmission level rate and a phase difference. For example, the transmission symbol series of the control channel is “0011” for the first base transmission antenna 9-1, and is “0101” for the second base transmission antenna 9-2, and two antennas make the diffusion codes identical.

The mobile station MS receives the down-radio signal transmitted from the first and the second base antennas 9-1 and 9-2 of the base station BS as the down-received signal by the mobile receiving antenna 10 and sends it to the mobile receiving portion (Rx) 11. The mobile receiving portion 11 performs back-diffusion on this down-received signal and outputs the back diffused signal. This back diffused information data is sent to the mobile demodulation portion 19. The mobile demodulation portion 19 decodes the back diffused information data signal, and outputs the down-received demodulated data from the down-received demodulated data output terminal 20.

Further, the mobile station MS receives a down-control channel signal transmitted from the first and the second base transmission antennas 9-1 and 9-2 of the base station BS by the mobile receiving antenna 10 and sends it to the mobile receiving portion (Rx) 11. The mobile receiving portion 11 performs the back-diffusion on this control channel signal, and outputs the back diffused control channel signal. This back diffused control channel signal is sent to the transmission line estimation portion 12. The transmission line estimation portion 12 performs back modulation on the back diffused control channel signal by transmission series and, after that, performs averaging. Note that an averaging time for averaging in the transmission line estimation portion 12 is, for example, one slot time (0.666 msec). The transmission line estimate obtained from the transmission line estimation portion 12 is sent to the transmission line estimation portion 13. The transmission line estimation portion 13 predicts the transmission line state of the down-link with the first and the second base transmission antennas 9-1 and 9-2 of the base station BS from this transmission line estimate value.

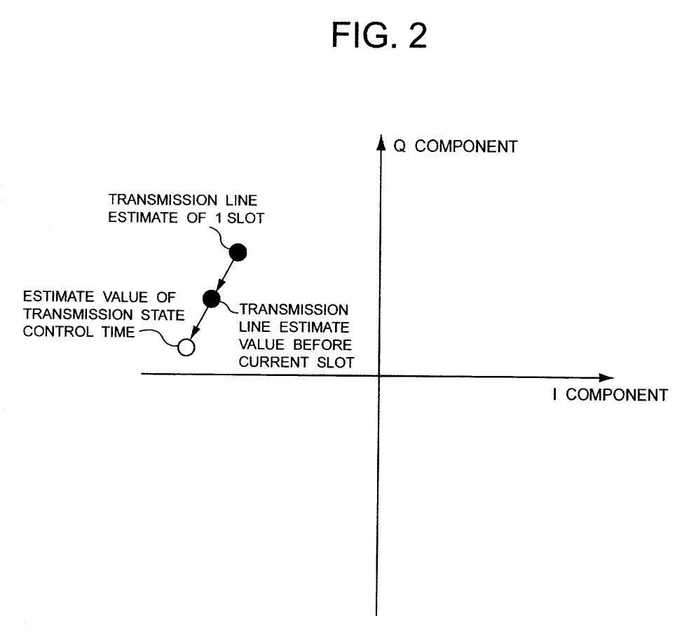

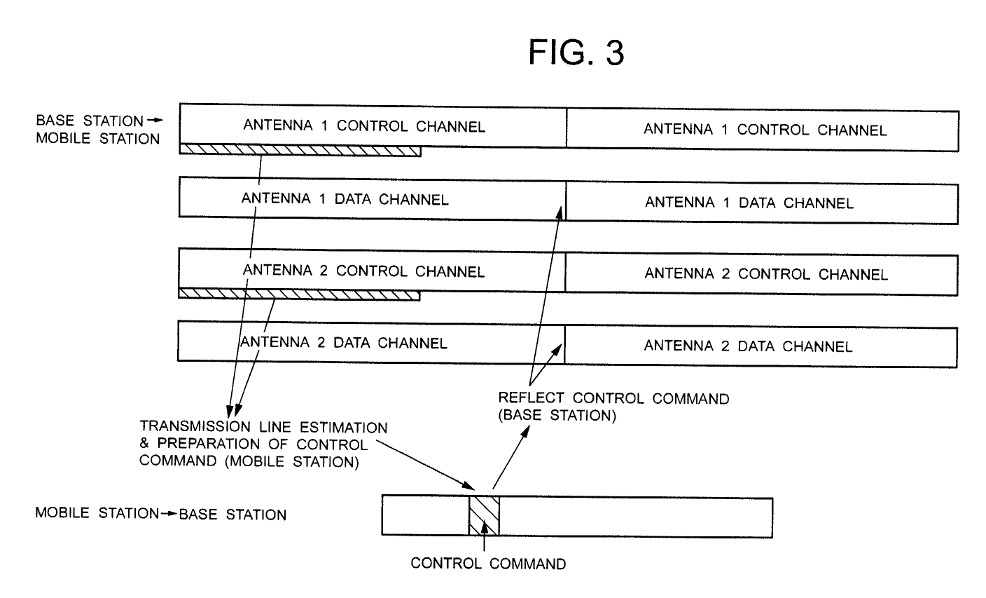

Next, the estimation method of the transmission line state in the transmission line estimation portion 13 will be described with reference to FIGS. 2 and 3. FIG. 2 is a processing explanatory view of the transmission line estimation portion 13, and FIG. 3 is a view showing an operation timing example of the down-link/the up-link. In FIG. 3, the antenna 1 shows the first base transmission antenna 9-1, and the antenna 2 shows the second base transmission antenna 9-2.

For example, a control delay from the time when the transmission line state is measured till the time when it is reflected as shown in FIG. 3 is taken as one slot. That is, the base station BS transmits the signals of an antenna 1 control channel, an antenna 1 data channel, an antenna 2 control channel, and an antenna 2 data channel to the mobile station MS for every one slot. The mobile station MS performs the creation of the transmission line estimation and the preparation of the control command on the basis of the signals of an antenna 1 control channel and an antenna 2 control channel. The mobile station MS transmits the signals including this prepared control command to the base station BS. The base station BS allows the received control command to reflect on the antenna 1 data channel and the antenna 2 data channel in the next slot.

In this case, the transfer estimation portion 13 predicts by performing an extrapolation primary interpolation on the transfer line estimation value after one slot from the transfer line estimation value before one slot and the transfer line estimation value of the current slot. In this way, the influence of the control delay in the closed loop is alleviated. Note that the transfer line estimation portion 13 may interpolate several times by using the transfer line estimation value also of not less than one slot.

In any case, the transfer line estimation portion 13 can obtain an estimated transfer line state of the down-link with the first and the second base transmission antennas 9-1 and 9-2 of the base station BS at a point of time when the transmission control is performed at the base station BS. The obtained estimated transfer line state is sent to the control command preparation portion 14.

The control command preparation portion 14 prepares the transmission state control command, which controls the transmission state of the base station BS, from this estimated transfer line state. Next, the preparation method of the transmission state control command at the control command preparation 14 will be described. For example, assume that the data channel is transmitted from the one base transmission antenna. In this case, the control command preparation portion 14 may issue an instruction to select the base transmission antenna, which is better in the transmission line state of the estimated down-link as a transmission state control command. Further, for example, assume that a phase difference is controlled. In this case, the control command preparation portion 14 may issue an instruction as the transmission control command that the transfer line estimation value of the estimated down-link be synthesized by all the settable phase differences so as to become the phase difference which is the highest in a synthetic level.

The transmission state control command prepared at the control command preparation portion 14 is supplied to the mixing portion 16. The mixing portion 16 mixes the transmission state control command and the up-transmission information data supplied from the up-transmission state data input terminal 15, and sends the mixed up-transmission information data to the mobile transmission portion (Tx) 17. The mobile transmission portion 17 performs modulation by the mixed up-transmission information data, and further performs diffusion modulation to transmit an up-radio signal from the mobile transmission antenna 18 via the up-link.

The demodulation portion 19 performs demodulation, and the received information data obtained in this way is outputted from the terminal 20.

The base station BS receives the up-radio signal from the up-link as the up-received signal by the base receiving antenna 1 and supplies it to the base receiving portion 2. The base receiving portion 2 performs back diffusion and demodulation on this up-received signal. The up-received data obtained in this way is outputted from the up-received information data output terminal 3. The base receiving portion 2 supplies the above described received transmission state control command to the transmission state control portion 6 and, at the same time, supplies the-up received signal to the up-link transmission line estimation portion 4 and the down-link transmission line state estimation portion 5.

The up-link transmission line state estimation portion 4 estimates (predicts) the transmission line state of the up-link on the basis of the up-link received signal transmitted from the up-link to be described later. Note that, in order to estimate (predict) the transmission line state of the up-link, the up-link transmission line state estimation portion 4 can use either one of a level of the channel of the up-link received signal, SIR (Signal to Interference Ratio) of the data after demodulation of the up-received signal, BER (Bit Error Rate) of the data after demodulation of the up-received signal, FER (Frame Error Rate) of the data after demodulation of the up-received signal and a level of the transmission line estimate.

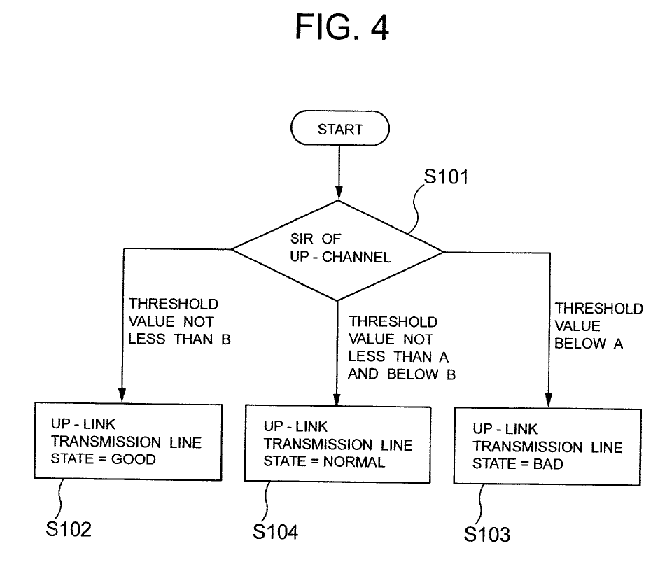

As one example, a flowchart of the up-link transmission line state estimation example in the up-link transmission line state estimation portion 4 in the case where the transmission line state of the up-link is estimated (predicted) by using SIR of the up-channel is shown in the flowchart of FIG. 4. Here, the up-link transmission line state estimation portion 4 is provided with a first threshold value A and a second threshold value B (>A) which is larger than the first threshold value A.

First, the up-link transmission line state estimation portion 4 obtains SIR of the up-channel (step S101). When the obtained SIR level of the up-channel is not less than the second threshold value B, the up-link transmission line state estimation portion 4 estimates that the transmission line state of the up-link is “good” (step S102). When the obtained SIR level of the up-channel is below the first threshold value A, the up-link transmission line state estimation portion 4 estimates that the transmission line state of the up-link is “bad” (step S103). In neither case, the up-link transmission line state estimation portion 4 estimates that the transmission line state of the up-link is “normal” (step S104). Of course, the state may be divided more into details.

The down-link transmission line state estimation portion 5 estimates (predicts) the down-link transmission line state by using a transmitted power control command (bit) sent from the mobile station MS via the up-link. In general, when the receiving state of the down-link is good at the mobile station MS, the transmitted power control command to lower the transmitted power is sent from the mobile station MS to the base station BS. Conversely, when the receiving state of the down-link is bad at the mobile station MS, the transmitted power control command to raise the transmitted power is sent from the mobile station MS to the base station BS.

For this reason, when the transfer line state (receiving state) is stabilized, the transmitted power control command to lower the transmitted power of the base station BS and the transmitted power control command to raise the transmitted power of the base station BS are almost alternately transmitted. On the other hand, when the transfer line state (receiving state) of the down-link is very good, the transmitted power control command to lower the transmitted power of the base station BS is continuously transmitted. Conversely, when the transfer line state (receiving state) of the down-link is very bad, the transmitted power control command to raise the transmitted power of the base station BS is continuously transmitted.

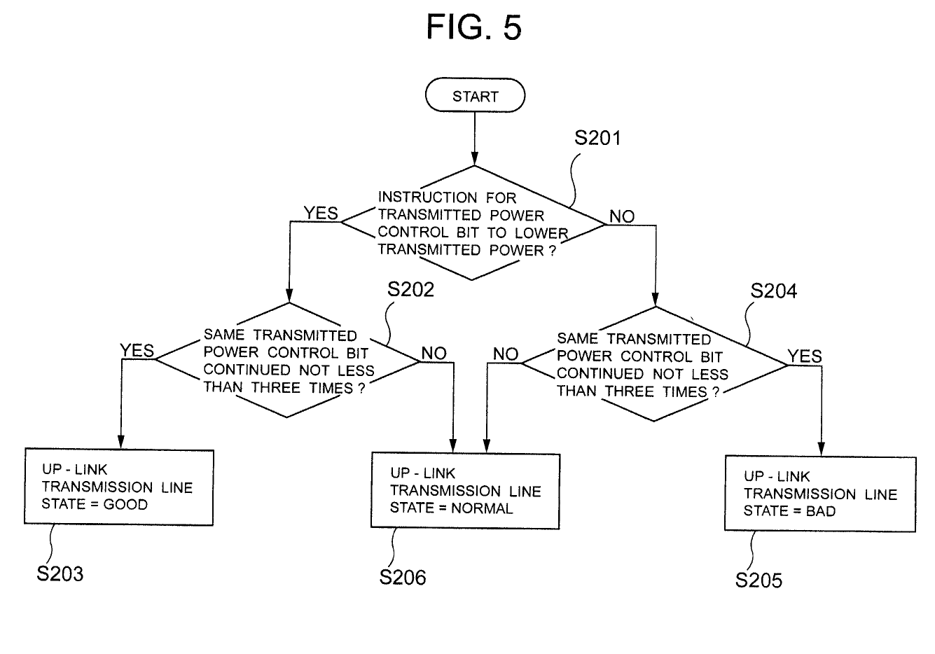

As one example, a flowchart of the down-link transmission line state estimation example in the down-link transmission line state estimation portion 5 in the case where the transmission line state of the down-link is estimated (predicted) on the basis of whether or not the same transmitted power control command (bit) continued not less than three times is shown in the flowchart of FIG. 5.

First, the down-link transmission line state estimation portion 5 determines whether or not the transmitted power control command (bit) sent from the mobile station MS via the up-link is an instruction to lower the transmitted power (step S201). If it is the instruction for the transmitted power control bit to lower the transmitted power (YES of step S201), the down-link transmission line state estimation 5 determines whether or not the transmitted power control command to lower the transmitted power of the base station BS was continuously sent not less than three times (step S202). If so (YES of step S202), the down-link transmission line state estimation portion 5 estimates (predicts) that the transmission line state of the down-link is “good” (step S203). If it is not the instruction for the transmitted power control bit to lower the transmitted power (NO of step S201), the down-link transmission line state estimation portion 5 determines whether or not the transmitted power control command to raise the transmitted power of the base station BS was continuously sent not less than three times (step S204). If so (YES of step of S204), the down-link transmission line state estimation portion 5 estimates (predicts) that the transmission line state of the down-link is “bad” (step S205). If neither case (NO of step S202, NO of step S204), the down-link transmission line state estimation portion 5 estimate (predicts) that the transmission line state of the down-link is “normal” (step S206). Of course, the state may be divided more into details.

The transmission state control portion 6 issues an instruction to control the transmission level and the phase difference of the first and the second base transmission antennas 9-1 and 9-2 of the base transmission portion 8 on the basis of the transmission state control command send from the base receiving portion 2 periodically, the up-link transmission line state from the up-link transmission line state estination portion 4 and the down-link transmission line state from the down-link transmission line state estimation portion 5. Specifically, when the transmission line state of the up-link is bad or when the transmission line state of the down-link is bad, the transmission state control portion 6 does not follow the transmission state control command sent from the up-link, but performs the control so as to transmit by the base transmission antenna having a good characteristic of the up-link or in a specific transmission state (for example, transmit by the specific antenna by stopping the transmission diversity). When the transmission line state of the up-link is good and, moreover, the transmission line state of the down-link is good, the transmission state control portion 6 performs the control to follow the transmission state control command sent by the up-link.

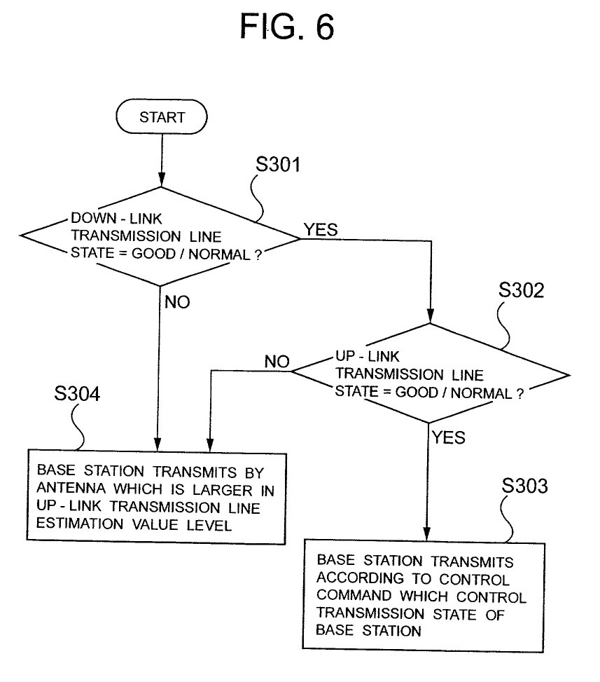

One example of the control operation in the transmission state control portion 6 is shown in the flowchart of FIG. 6. First, the transmission state control portion 6 determines whether or not the transmission line state of the down-link is “good” or “normal” (step S301). If so (YES of step S301), the transmission line control portion 6 determines whether or not the transmission line state of the up-link is “good” or “nomal” (step S302). If so (YES of step S302), the transmission line control portion 6 performs the control to follow the transmission control command sent by the up-link. That is, when the transmission line state of the up-link is good (or normal) and the transmission line state of the down-link is good (or normal), the transmission line state control portion 6 performs the control to follow the transmission line control command sent by the up-link (step S303). On the other hand, when the transmission line state of the up-link is bad (No of step S302) or the transmission line state of the down-link is bad (NO of step S301), the transmission state control portion 6 does not follow the transmission state control command sent by the up-link, but performs the control so as to transmit by the antenna having a good characteristic of the up-link (step S304).

Of course, it can be also applied in case of controlling the transmission ratio and the phase difference other than the antenna switching transmission diversity.

The base transmission portion 8 transmits the down-transmission information data from the down-transmission information data input terminal 7 from the first and/or the second base transmission antennas 9-1 and/or 9-2 with the transmission state instructed by the transmission line control portion 6.

As described above, while the present invention has been described by the preferred embodiment by citing examples, needless to mention, the present invention is not limited by the above embodiment.

As apparent from the above described description, since the present invention monitors the transmission line state of the up-link and the transmission line state of the down-link, even when the transmission line state of the up-link and the transmission line state of the down-link are bad, it is possible to prevent the deterioration of the receiving performance of the mobile station due to the transmission diversity function of the base station.

What is claimed is:

1. A CDMA base station, which receives a transmission state control command from a mobile station via an up-link so as to make a receiving state of a down-link good in the mobile station and which controls a transmission state of the CDMA base station having not less than two transmission antennas on the basis of the transmission state control command, comprising:
a receiving portion which receives a signal from said up-link;
an up-link transmission line state estimation portion which estimates the transmission line state of said up-link with the transmission antenna of said mobile station from said received signal;
a down-link transmission line state estimation portion which estimates the transmission line state of said down-link from said received signal;
a transmission state control portion which controls the transmission state of said CDMA base station on the base of said transmission state control command taken from said received signal, the transmission line state of said estimated up-link and the transmission state of said estimated down-link transmission line state estimation; and
a transmission portion which performs transmission processing in a transmission state instructed from said transmission state control portion.

2. The CDMA base station according to claim 1, wherein said up-link transmission state estimation portion estimates the transmission line state of said up-link from a level of said received signal.

3. The CDMA base station according to claim 1, wherein said up-link transmission line state estimation portion estimates the transmission line state of said up-link from SIR of the data obtained by demodulating said received signal.

4. The CDMA base station according to claim 1, wherein said up-link transmission line state estimation portion estimates the transmission line state of said up-link from BER of the data obtained by demodulating said received signal.

5. The CDMA base station according to claim 1, wherein said up-link transmission line state estimation portion estimates the transmission line state of said up-link from FER of the data obtained by demodulating said received signal.

6. The CDMA base station according to claim 1, wherein
said up-link transmission line state estimation portion estimates the transmission line state of said up-link from a level of the transmission line estimate value of said received signal.

7. The CDMA base station according to claim 1, wherein
said down-link transmission line state estimation portion estimates the transmission line state of said down-link from a transmitted power control command column which is contained in said received signal.

8. The CDMA base station according to claim 1, wherein said transmission state control portion does not follow said transmission state control command sent by said up-link when the transmission line state of said up-link is bad or the transmission line state of said down-link is bad, but performs the control so as to transmit by the transmission antenna having a good characteristic of said up-link and, when the transmission line state of said up-link is good and, moreover, the transmission line state of said down-link is good, performs the control so as to follow said transmission state control command by said up-link.

9. The CDMA base station according to claim 1, wherein said transmission state control portion does not follow said transmission state control command sent by said up-link when the transmission line state of said up-link is bad or the transmission line state of said down-link is bad, but performs the control so as to transmit in a specific transmission state and,
when the transmission line state of said up-link is good and, moreover, the transmission line state of said down-link is good, performs the control so as to follow said transmission state control command by said up-link.

10. A transmission diversity control method, which transmits a transmission state control command from a mobile station via an up-link in order to improve a receiving state of a down-link in said mobile station and which controls the transmission state of a base station having not less than two transmission antennas on the basis of the transmission state control command, comprising the steps of:
receiving a signal from said up-link;
estimating the transmission line state of said up-link with the transmission antenna of said mobile station from said received signal;
estimating the transmission line state of said down-link from said received signal; and
controlling the transmission state of said base station from said transmission state control command taken from said received signal, the transmission line state of said estimated up-link and said estimated down-link transmission line state.

11. The transmission diversity control method according to claim 10, wherein the step of estimating the transmission line state of said up-link estimates the transmission line state of said up-link from a level of said received signal.

12. The transmission diversity control method according to claim 10, wherein the step of estimating the transmission line state of said up-link estimates the transmission line state of said up-link from SIR of the data obtained by demodulating said received signal.

13. The transmission diversity control method according to claim 10, wherein the step of estimating the transmission line state of said up-link estimates the transmission line state of said up-link from BER of the data obtained by demodulating said received signal.

14. The transmission diversity control method according to claim 10, wherein the step of estimating the transmission line state of said up-link estimates the transmission line state of said up-link from FER of the data obtained by demodulating said received signal.

15. The transmission diversity control method according to claim 10, wherein the step of estimating the transmission line state of said up-link estimates the transmission line state of said up-link from a level of the transmission line estimate value of said received signal.

16. The transmission diversity control method according to claim 10, wherein the step of estimating the transmission line state of said down-link estimates the transmission line state of said down-link from the transmitted power control command column included in said received signal.

17. The transmission diversity control method according to claim 10, wherein the step of controlling said transmission state does not follow said transmission state control command sent by said up-link when the transmission line state of said up-link is bad or the transmission line state of said down-link is bad and performs the control so as to transmit by the transmission antenna having a good characteristic of said up-link and, when the transmission line state of said up-link is good and, moreover, the transmission line state of said down-link is good, performs the control so as to follow said transmission state control command sent by said up-link.

18. The transmission diversity control method according to claim 10, wherein the step of controlling said transmission state does not follow said transmission state control command sent by said up-link when the transmission line state of said up-link is bad or the transmission line state of said down-link is bad and performs the control so as to transmit in a specific transmission state and, when the transmission line state of said up-link is good and, moreover, the transmission line state of said down-link is good, performs the control so as to follow said transmission state control command sent by said up-link.
